(19) United States
(12) Patent Application Publication
(10) Pub. No.: US 2006/0166848 A1
(43) Pub. Date: Jul. 27, 2006

(54) Solid formulations

(75) Inventors: Mattia De Dominicis, San Martino di Lupari (IT); Zefferino Righetto, Venice (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser N. V., Hoofdddorp (NL)

(21) Appl. No.: 10/521,801

(22) PCT Filed: Aug. 5, 2003
(86) PCT No.: PCT/GB03/03425

§ 371 Date: Jan. 21, 2005

(30) Foreign Application Priority Data
Aug. 6, 2002 (GB) 0218194.9

(51) Int. Cl. C11D 3/00

(52) U.S. Cl. 510/278

(57) ABSTRACT

The invention relates to a method of cleaning carpet, the method comprising the addition to the reservoir of a carpet cleaning machine a water-soluble solid product comprising a carpet cleaning composition, adding water to the reservoir of the carpet cleaning machine prior to or after adding the solid product, and operating the carpet cleaning machine on a solid carpet.

The invention relates to a method of cleaning carpet, the method comprising the addition to the reservoir of a carpet cleaning machine a water-soluble solid product comprising a carpet cleaning composition, adding water to the reservoir of the carpet cleaning machine prior to or after adding the solid product, and operating the carpet cleaning machine on a soiled carpet.

The present invention relates to water-soluble solid products for carpet cleaning machines, preferably in the form of a powder, granule, pellet or tablet, and methods of making such a solid product and methods of using such a product. Preferred solid products are tablets that have been specifically designed for carpet cleaning and especially for carpet cleaning extraction machines. The solid products of the invention need to be soluble in water and to dissolve in a short time period, typically less than 5 minutes, without any stirring, to produce a product having low or no solid residue. A common feature of many carpet cleaning machines is the inclusion of a fine mesh which acts as a filter preventing solid material from entering and damaging the pumping mechanisms. Therefore, it is important that there are no solid residues in the reservoir, so as to avoid any blockages.

US 20020082187 describes the use of expanded sodium perborate as a carrier for liquids, to be used for cleaning carpets. In passing it is mentioned that the composition may be presented as a tablet.

We present as a feature of the invention a method of cleaning a soiled carpet the method comprising adding to the reservoir of a carpet cleaning machine a water-soluble solid product comprising a carpet cleaning composition, adding water to the reservoir of the carpet cleaning machine prior to or after adding the solid product, and operating the carpet cleaning machine on the soiled carpet.

Preferably the solid product is added to the reservoir of the carpet cleaning machine prior to adding the water.

The solid product may be a powder, granule, pellet or a tablet. Preferably the solid product is a tablet.

Preferably a combination of effervescent technology, which uses a carbonate/bicarbonate with an acid, and optionally a swelling disintegrant is used to obtain rapid dissolution. The pre-dosed solid product is put into the carpet cleaner machine tank with water. The product dissolves quickly so that it is possible to start cleaning in a short period of time without danger of blocking the machine.

The product provides the consumer with a convenient solid form, which is pre-dosed when in tablet form, avoiding the need to dilute the product before it is added to the machine, which may be necessary with liquid concentrate formulations.

A problem associated with cleaning carpets is the high repellancy of the carpet to water. This is primarily caused from two sources, the first being the amount of soiling which can accumulate on carpets and, secondly, the prevalence of stain repelling treatments which are increasingly commonly applied to carpets either during manufacture or by the consumer. In this invention a “super wetting” agent is added to the composition and is a special surfactant added at levels of below 10% w/w of the composition, preferably below 9, 8, 7, 6 or 5% w/w, of the composition. It is preferred that at the levels described above, and in combination with any other surfactant present, it is able to lower the surface tension of the final liquid cleaning formulation to values below 28 mN/m, when 1 to 25 g, ideally 2 to 12 g, preferably 3 to 10 g, or 15 g of the solid composition is dissolved in 4 litres of water.

We present as a further feature of the invention a water-soluble carpet cleaning composition in solid form comprising at least one surfactant and at least one super wetting agent wherein the combined effect of the surfactant and the super wetting agent in the composition is capable of reducing the surface tension of water below 28 mN/m when 1 to 25 g, ideally 15 g of the composition is dissolved in 4 litres of water.

We have developed a product that contains a composition particularly suitable for carpet cleaning extraction machines. These compositions comprise at least one surfactant and at least one super wetting agent. Preferably these compositions additionally comprise from 5 to 50%, 10 to 50%, 12 to 45% w/w of at least one of the following: a builder, an antifoaming agent, a dispersing agent or an antiresoiling agent. The composition may also compare up to 15%, 10%, 8%, 6%, 4% w/w or 2% w/w and at least one of the following optional ingredients such as, solvent, fragrance, preservative, dye, bactericide and filler.

Other ingredients which may form part of this invention are disintegrants to provide quick dissolution in water without the need for any stirring or agitation, flowing agents to improve the flowability of the solids during manufacturing, anti-cake and anti-stick agents to reduce the stickiness of the solids to the mould during powder tabletting, binding agents to provide products with good cohesion and adsorbing products which entrap any fragrance that is present.

Preferably from 1 to 25 g of product is used per machine, ideally from 2 to 22 g, and preferably from 10 to 20 g.

Surfactant

Preferred levels of surfactant are from 1 to 40% w/w, ideally 10 to 20% wt and preferably 15 to 19% w/w. Non ionic and anionic surfactants can be used.

The non-ionic surfactant is preferably a surfactant having a formula RO(CH2CH20)nH wherein R is a mixture of linear, even carbon-number hydrocarbon chains ranging from C12H25 to C16H33 and n represents the number of repeating units and is a number of from about 1 to about 12. Examples of other non-ionic surfactants include higher aliphatic primary alcohols containing about twelve to about 16 carbon atoms which are condensed with about three to thirteen moles of ethylene oxide.

Other examples of non-ionic surfactants include primary alcohol ethoxylates (available under the Neodol tradename from Shell Co.), such as C11 alkanol condensed with 9 moles of ethylene oxide (Neodol 1-9), C12-13 alkanol condensed with 6.5 moles ethylene oxide (Neodol 23-6.5), C12-13 alkanol with 9 moles of ethylene oxide (Neodol 23-9), C12-15 alkanol condensed with 7 or 3 moles ethylene oxide (Neodol 25-7 or Neodol 25-3), C14-15 alkanol condensed with 13 moles ethylene oxide (Neodol 45-13), C9-11 linear ethoxylated alcohol, averaging 2.5 moles of ethylene oxide per mole of alcohol (Neodol 91-2.5), and the like.

Other examples of non-ionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C11-15 secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type non-ionic surfactants, for example, Triton X-100, as well as amine oxides can also be used as a non-ionic surfactant in the present invention.

Other examples of linear primary alcohol ethoxylates are available under the Tomadol tradename such as, for example, Tomadol 1-7, a C11 linear primary alcohol ethoxylate with 7 moles EO; Tomadol 25-7, a C12-C15 linear primary alcohol ethoxylate with 7 moles EO; Tomadol 45-7, a C14-C15 linear primary alcohol ethoxylate with 7 moles EO; and Tomadol 91-6, a C9-C11 linear alcohol ethoxylate with 6 moles EO.

A preferred surfactant is an anionic surfactant. Such anionic surface-active agents are frequently provided in a salt form, such as alkali metal salts, ammonium salts, amine salts, aminoalcohol salts or magnesium salts. Contemplated as useful are one or more sulfate or sulfonate compounds including: alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Particularly preferred are alkyl naphthalene sulfonate anionic surfactants of the formula: 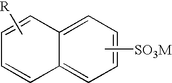
wherein R is a straight chain or branched alkyl chain having from about 1 to about 25 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation.

Most desirably, the anionic surfactant according to constituent is selected to be of a type that dries to a friable powder. This facilitates their removal from carpets and carpet fibres, such as by brushing or vacuuming.

Super Wetting Agent

A super wetting agent is capable of reducing the surface tension in water to values below 25 mN/m, in the range between 18 and 25 mN/m at concentrations of 0.0001-1% w/v, preferably between 0.001 and 0.1% w/v (when a 15 gram composition is dissolved in 4 litres of water).

Preferred levels in the solid composition are between 0.01 and 10% w/w. Examples of super wetting agents of this invention are silicone glycol copolymers and flurosurfactants. The silicone glycol copolymers are described by the following formula 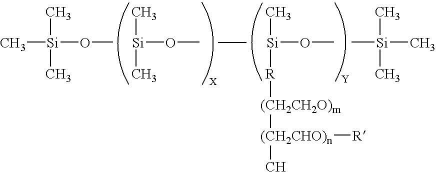
wherein x, y, m and n are each an integer ranging from 0 to 25 (X is preferred between 0-10 and y, m and n between 0-5); R and R′ are either a straight or branched alkyl chain having from 1 to 25 carbon atoms, saturated or unsaturated, and the longest linear portion of the alkyl chain is 15 carbon atoms or less on the average.

The fluorinated surfactant is described in the following formulae:
F(CF₂)ₙ—CH₂CH₂—S—CH₂CH₂—COOM
F(CF₂)ₙ—N(CH3)(CH2)3-(CH₂CH₂O)ₓOSO₂M
CF₃(CF₂CF₂)ₙ(CFCF)ₘ—(CH₂CH₂O)ₓ—OPO₃M₂
Wherein n, m and x are each integers having a value from 0 to 15; preferred values are between 1 and 12. M is a cation which makes the compound water soluble especially an alkali metal such as sodium or magnesia, armonium or substituted ammonium cation.

Antifoaming

Antifoaming agents are an important addition to carpet cleaning compositions of this invention, they are used at a level between 0.01 and 5% w/w. A very high foam level may not allow the carpet cleaning machine to function properly and tends to reduce the mechanical action of the carpet cleaner machine brushes, thus having a detrimental impact on soil removal. Antifoaming agents are also considered important components of this invention.

Examples are polydimethylsiloxanes, preferably in combination with hydrophobic silica.

Builders

The carpet cleaning composition comprises at least one builder active or better a combination of builders from 1 to 90% w/w, preferably from 65 to 85% w/w.

Suitable polymer water-soluble compounds include the water soluble monomeric polycarboxylates, or their acid forms, homo or copolymeric polycarboxylic acids or their salts in which the polycarboxylic acid comprises at least two caroxylic radicals separated from each other by not more than two carbon atoms, carbonates, bicarbonates, borates, phosphates, and mixtures of any of thereof.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates contining sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane -hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred polymers are homo-polymers, copolymers and multiple polymers of acrylic, flourinated acrylic, sulfonated styrene, maleic anhydride, metacrylic, iso-butylene, styrene and ester monomers.

Examples of these polymers are Acusol supplied from Rohm & Haas, Syntran supplied from Interpolymer and Versa and Alcosperse series supplied from Alco Chemical, a National Starch & Chemical Company.
The parent acids of the monomeric or oligomeric polycarboxylate chelating agents or mixtures therefore with their salts, e.g. citric acid or citrate/citric acid mixtures are also contemplated as useful builder components.
Borate builders, as well as builders containing borate-forming materials than can produce borate under detergent storage or wash conditions can also be.
Iminosuccinic acid metal salts.
Polyaspartic acid metal salts.
Examples of bicarbonate and carbonate builders are the alkaline earth and the alkali metal carbonates, including sodium carbonate and sesqui-carbonate and mixtures thereof. Other examples of carbonate type builders are the metal carboxy glycine and metal glycine carbonate.
Ethylene diamino tetra acetic acid and salt forms.
Water-soluble phosphonate and phosphate builders are useful for this invention. Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid.

Specific examples of water-soluble phosphate builders are the alkali metal tripolyphosphates, sodium potassium and ammonium pyrophosphate, sodium and potassium and ammonium pyrophosphate, sodium and potassium orthophosphate, sodium polymeta/phosphate in which the degree of polymerization ranges from 6 to 21, and salts of phytic acid.

Additional ingredients important for the tabletting of the composition, are selected from the commonly found in detergent tablet compositions, such as described in WO 0233038, and include.

Disintegrants
Suitable cross-linked polymeric disintegrants for use herein include cross-linked starches, cross-linked cellulose ethers, cross-linked polyvinylpyrrolidones, cross-linked carboxy-substituted ethylenically-unsaturated monomers, cross-linked polystyrene sulphonates and mixtures thereof. High preferred are the cross-linked polyvinylpyrrolidones. Suitable cross-linking agents include bi- and multi-functional linking moieties selected from divinyl and diallyl cross-linkers, polyols, polyvinylalcholols, polyalkylenepolymines, ethyleneimine containing polymers, vinylamine containing polymers and mixtures thereof. Alternatively, the vinylpyrrolidone can be cross-linked in-situ by so-called proliferous polymerisation.

Suitable additional disintegrants include:
a) non-cross and cross linked polymeric disintegrants;
b) water-soluble hydrated salts having a solubility in distilled water of at least about 25 g/100 g at 25° C.;
c) effervescent agents; and
d) mixtures thereof.

Levels of disintegrant are from 0.1% w/w to 20% w/w, preferably up to 10% w/w.

Preferred water-soluble hydrated (fully or partially) salts are selected from hydrates of sodium acetate, sodium metaborate, sodium orthophosphate, sodium dihydrogenphosphate, disodium hydrogen phosphate, sodium potassium tartrate potassium aluminium sulphate, calcium bromide, calcium nitrate, sodium citrate, potassium citrate and mixtures thereof. Particularly suitable materials include sodium acetate trihydrate, sodium metaborate tetrahydrate or octahydrate, sodium orthophosphate dodecahydrate, sodium dihyrogen phosphate dihydrate, the di-, hepta- or dodeca-hydrate of disodium hydrogen phosphate, sodium potassium tartrate tetrahydrate, potassium aluminium sulphate dodecahydrate, calcium bromide hexahydrate, tripotassium citrate monohydrate, calcium nitrate tetrahydrate and sodium citrate dihydrate. In preferred embodiments, the water-soluble hydrated salt is selected from water-soluble mono-, di- tri- and tetrahydrate salts and mixtures thereof. Highly preferred herein is sodium acetate trihydrate, tripotassium citrate monohydrate, mixed alkali-metal citrates containing at least one potassium ion and mixtures thereof. Highly preferred are sodium acetate trihydrate and tripotassium citrate monohydrate.

Where an effervescence system is present it comprises as its components, an acid and a carbonate source, capable of formation of carbon dioxide upon contact with water.

The acid source component may be any organic, mineral or inorganic acid, or a derivative thereof, or a mixture thereof. Preferably the acid source component comprises an acid or partially salified polymer.

The acid compound is preferably substantially anhydrous or low-hygroscopic and the acid is preferably water-soluble. It may be preferred that the acid source is overdried.

Suitable acids source components include acidic polymers already described previously as builders, citric, maleic, malic, fumaric, aspartic, glutaric, tartaric succinic or adipic acid, monosodium phosphate, boric acid, or derivative thereof acidic polymers are especially preferred.

As discussed above, the effervescence system preferably comprises an alkali source, however, for the purpose of the invention, it should be understood that the alkali source may be part of the effervescence particle or can be part of the cleaning composition comprising the particle, or can be present in the washing liquor, whereto the particle or the cleaning composition is added.

Any alkali source which has the capacity to react with the acid source to produce a gas may be present in the particle, which may be any gas known in the art, including nitrogen oxygen and carbon dioxide gas.

Preferred can be perhydrate bleaches, including perborate, and silicate material. The alkali source is preferably substantially anhydrous or non-hydroscopic. It may be preferred that the alkali source is overdried. Preferably this gas is carbon dioxide, and therefore the alkali source is a preferably a source of carbonate, which can be any source of carbonate known in the art. In a preferred embodiment, the carbonate source is a carbonate and bicarbonate salts. Examples of preferred carbonates are the alkaline earth and alkali metal bicarbonates and carbonates, including sodium or potassium carbonate, bicarbonate and sesqui-carbonate and any mixtures thereof with ultra-fine calcium carbonate such as are disclosed in German Patent Application No. 2,321,001 published on Nov. 15, 1973. Alkali metal percarbonate salts are also suitable sources of carbonate species, which may be present combined with one or more other carbonate sources.

The carbonate and bicarbonate preferably have an amorphous structure. The carbonate and/or bicarbonates may be coated with coating materials.

The molecular ratio of the acid source to the alkali source present in the particle core is preferably from 50:1 to 1:50, more preferably from 20:1 to 1:20 more preferably from 10:1 to 1:10, more preferably from 5:1 to 1:3, more preferably from 3:1 to 1:2, more preferably from 2:1 to 1:2.

Flow Agents

Examples are silica powder, talc and metal stearates. They improve the flowability of the powder during manufacturing and they reduce the stickiness of the powder to the mould during powder tabletting

Binding Agents

Examples of binders are polyethylene and polypropylene glycol with an average molecular weight ranging from 100 to 10000 and non cross-linked starches, cellulose ethers, polyvinylpyrrolidones, carboxy-substituted ethylenically-unsaturated monomers, polystyrene sulphonates and mixtures thereof. High preferred are the polyvinylpyrrolidones.

Solvents

The solvent constituent of the inventive compositions include one or more alcohols, glycols, acetates, ether acetates and glycol ethers. Exemplary alcohols useful in the compositions of the invention include C2-C8 primary and secondary alcohols which may be straight chained or branched. Exemplary alcohols include pentanol and hexanol. Exemplary glycol ethers include those glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units. By way of further non-limiting example specific organic constituents include propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate and particularly useful is, propylene glycol phenyl ether.

Process Manufacturing:

The powder raw materials can be mixed directly or liquid spraying process can be required for certain raw materials such as fragrances, super wetting agents and antifoaming agents.

A wet granulation process could be required so that the fine powder ingredients are granulated with a water based formulation containing several ingredients as for example antifoaming agent, superwetting agent, dyes and fragrance. After the granulation the wet powder is dried, then sieved and mixed with other coarse powders.

The tablets may be manufactured by using any compacting process, such as tabletting, briquetting, or extrusion, preferably tabletting. Suitable equipment includes a standard single stroke or a rotary press (such as Courtoy.RTM., Korsch.RTM., Manesty.RTM., or Bonals.RTM.).

Examples of suitable tablet shapes are cylindrical, spherical and cubic.

The compaction pressure used for preparing these tablets is in the range 1000-20000 kN/m², preferably between 1500 and 10000 kN/m².

Evaluation Test

The tablets have been evaluated in terms of surface tension when dissolved in deionised water, dissolution time in warm water (T=40° C.), remaining residue after dissolution and soil removal performance versus Resolve™ for steam machine taken as a reference of the machine carpet cleaner products.

Surface Tension Measurements:

The surface tension has been measured with a surface tensiometer, by the ring method. A platinum du Nuoy ring is immersed in 12 French degree water solution maintained at 20° C., where previously has been dissolved a tablet. The ring is taken out slowly from the liquid. When the ring is near the air/liquid interface, it is balance by the tensiometer. The maximum force versus area gained before breaking the liquid film formed is the surface tension of the liquid.

The lower the surface tension expressed in mN/m, the better the formula performance in terms of wettability on carpet surface.

A surface tension target value for the composition is below 28 mN/m.

Dissolution and Residue Evaluation Test:

One tablet of 15 grams is put in a beaker containing 41 of warm water (T=40° C.). The effervescent effect, the dissolution time as well as the remaining residue quantity are considered and recorded.

A table with all parameter ratings is reported below:

| Dissolution | Effervescent | Dissolution | |
|---|---|---|---|
| rating | effect | time | Residue |
| 0 | No effect | More than 30 | More than 20% wt |
| | | minutes | |
| 1 | No effect | More than 10 | More than 20% wt |
| | | minutes | |
| 2 | Low | More than 10 | More than 10% wt |
| | | minutes | |
| 3 | Medium | Between 5 and 10 | More than 10% wt |
| | | minutes | |
| 4 | Medium | Between 5 and 10 | Between 5 and 10% wt |
| | | minutes | |
| 5 | Strong | Between 5 and 10 | Between 5 and 10% wt |
| | | minutes | |
| 6 | Strong | Less than 5 | Between 5 and 10% wt |
| | | minutes | |
| 7 | Strong | Less than 5 | Less than 5% wt |
| | | minutes | |

The higher the rating number, the better the dissolution.

Soil Removal Test:

This method has been designed for the evaluation of soil removal performance of extraction cleaner formulations. The soil has the following composition:

| Soil components: | % by weight |
|---|---|
| Peat Moss | 47.7 |
| Cement | 21.4 |
| Kaolin clay | 8.0 |
| Silica | 8.0 |
| Red Iron oxide | 1.3 |
| Charcoal | 12.6 |
| Mineral oil | 1.0 |

A white nylon carpet is used for the test.

The carpet is soiled with 5 grams of standard soil. The soil is applied 1 gram once by strainer. The soiled carpet is then put with 4 kg of steel beads in the jar mill and stirred for 30 minutes at 56 rpm.

They are dissolved in warm tap water (T=40° C.), one 15 grams per 4 l of water. The Resolve for steam machine is diluted according to its labelling instructions.

Carpet is cleaned with appropriate machine/product using 4 wet strokes (dispensing solution) and 2 dry strokes (vacuuming up solution).

Carpet swatches are placed in a dark room temperature chamber (25° C./50% RH) for 24 hours while they dry.

The cleaning performance is evaluated by measuring the carpet with a portable spectrophotometer before soiling, after soiling and after the cleaning process. The result is reported as soil removal percentage.

### EXAMPLES:

The fined powder are typically granulated with a water formulation, then dried and mixed with the remaining coarse powder ingredients Examples of compositions forming a part of the present invention are set below in Table 1 with the various components identified in Table 2.

TABLE 1

| | Ex 1 | Ex 2 | Ex 3 | Ex 4 | Ex 5 | Ex 6 |
|---|---|---|---|---|---|---|
| Components | % | % | % | % | % | % |
| Baypure CX100 | 7.28 | | | | | |
| Baypure DS100 | 0.82 | | | | | |
| Citric acid | 14.00 | 14.00 | | | 7.00 | |
| anhydrous DC F20 | | | | | | |
| Bicar-TEC 27/50 G | 15.00 | 15.00 | 15.00 | 15.00 | 13.00 | 15.00 |
| Tri-sodium citrate | 9.20 | 18.30 | 8.80 | 8.80 | | 7.82 |
| dehydrate F6000 | | | | | | |
| Sodium carbonate | 26.00 | 26.00 | 26.00 | 24.80 | 33.30 | 25.32 |
| anhydrous | | | | | | |
| PEG 6000 | 4.00 | 4.00 | 4.00 | 4.00 | 4.00 | 2.50 |
| Petro 11 powder | 16.50 | 16.50 | 16.50 | 16.50 | 16.50 | 16.85 |
| Syntran DX 102-2-3 | 1.00 | | | | | |
| Acusol WE | | | 23.50 | 24.70 | 20.00 | 24.70 |
| Disintex 75 | 1.00 | 1.00 | 1.00 | 1.00 | 1.00 | 1.00 |
| DC Q2-5211 | 4.00 | 4.00 | 4.00 | 4.00 | 4.00 | 4.09 |
| Dye | | | | | | 0.02 |
| Fragrance | | | | | | 0.50 |
| Sipernat 22 S | | | | | | 1.00 |
| BF 20 PLUS | 1.20 | 1.20 | 1.20 | 1.20 | 1.20 | 1.20 |

TABLE 2

| Component | Description of component |
|---|---|
| Baypure CX100 | Imminodisuccinic acid sodium salt from Bayer |
| Baypure DS100 | Polyaspartic acid sodium salt from Bayer |
| Citric acid | Starch coated citric acid from Jungbunzlauer |
| anhydrous DC F20 | |
| Bicar-TEC 27/50 G | Sodium bicarbonate from Solvay |
| Tri-sodium citrate | Tri-sodium citrate dehydrate from |
| dehydrate F6000 | Jungbunzlauer |
| Sodium carbonate | Sodium carbonate anhydrous light from Solvay |
| anhydrous | |
| PEG 6000 | Polyethylene glycol 6000 from Medivete Padana |
| Petro 11 powder | Sodium alkyl naphthalene sulfonate from Witco |
| Syntran DX 102-2-3 | Acrylic polymer from Interpolymer |
| Acusol WE | Acrylic polymer from Rohm & Haas |
| Sipernat 22 S | Silica powder from Degussa |
| Fragrance | Proprietary fragrance from various suppliers |
| Dye | Proprietary dye from various suppliers |
| Disintex 75 | Cross-linked polyvinyl polypyrrolidinone from |
| | ISP |
| DC Q2-5211 | Methyl(propylhydroxide, ethoxylated)bis(trimethyl- |
| | siloxy) silane from Dow Corning |
| BF 20 PLUS | Silicone emulsion from Dow Corning |

### EXAMPLE RESULTS:

The tablet example products have been compared with Resolve™ for steam machine carpet cleaner in terms of soil removal performance. Oxi Clean™ multi specialist powder from Orange Glo Int. and Bissell™ booster powder from Bissell have been used for comparing the dissolution performance.

Results for table 1 formulations:

| | Surface | Dissolution | Soil Removal |
|---|---|---|---|
| Product | tension (mN/m) | rating | percentage |
| Ref 1 | 29 | — | 24.0 |
| (Resolve steam | | | |
| Ref 2 | — | 0/1 | — |
| (Oxi clean | | | |
| Ref 3 | — | 1 | — |
| (Bissell | | | |
| Ex 1 | — | 7 | 26.2 |
| Ex 2 | 27.8 | 6 | 24.0 |
| Ex 3 | — | 6 | 26.5 |
| Ex 4 | 24.5 | 7 | 26.8 |
| Ex 5 | 25.6 | 7 | 25.1 |
| Ex 6 | 24.0 | 7 | 28.9 |

1. A method of cleaning a soiled carpet the method comprising adding to the reservoir of a carpet cleaning machine a water soluble solid product comprising a carpet cleaning composition, adding water to the reservoir of the carpet cleaning machine prior to or after adding the water soluble solid product, and operating the carpet cleaning machine on the soiled carpet.

2. A method according to claim 1 wherein the water soluble solid product is added to the reservoir of the carpet cleaning machine prior to adding the water.

3. A method according to claim 2 wherein the water soluble solid product is a powder, granule, pellet or a tablet.

4. A method according to claim 3 wherein the solid is a tablet.

5. A method according to claim 1 wherein the carpet cleaning composition comprises at least one surfactant and at least one super wetting agent and wherein the combined effect of the surfactant and the super wetting agent in the composition is capable of reducing the surface tension of water below 28 mN/m when 15 g of the composition is dissolved in 4 litres of water.

6. A water-soluble carpet cleaning composition in solid form comprising at least one surfactant and at least one wetting agent wherein the combined surface tension effect of the surfactant and the super wetting agent in the composition is capable of reducing the surface tension of water below 28 mN/m when 15 g of the solid product is dissolved in 4 litres of water

7. A water-soluble carpet cleaning composition in solid form according to claim 6 which additionally comprises a builder, a disintegrant, an antifoaming agent, a solvent and a fragrance.

8. A water-soluble carpet cleaning composition in solid form according to claim 6 which is in a tablet form.

9. A water-soluble carpet cleaning composition in solid form according to claim 6 which additionally comprises one or more of: a builder, a disintegrant, an antifoaming agent, a solvent and a fragrance.
